(19) United States
(12) Patent Application Publication
(10) Pub. No.: US 2014/0225842 A1
(43) Pub. Date: Aug. 14, 2014

(54) METHOD OF CONTROLLING UNLOCKING OPERATION OF A DEVICE DRIVER OF AN ANDROID-BASED DEVICE

(71) Applicant: III TECHNOLOGY CORPORATION, Jhubei City (TW)

(72) Inventors: Tzu-Hua HSU, Yangemi City (TW); Chao-Feng Chang, Pingtung City (TW); Yi-Cheng Liu, Taichung City (TW)

(73) Assignee: IIi Technology Corporation, Jhubei City (TW)

(21) Appl. No.: 13/767,809

(22) Filed: Feb. 14, 2013

(51) Int. Cl. G06F 3/041

(52) U.S. Cl. CPC G06F 3/0416
USPC 345/173

(57) ABSTRACT

A method of controlling unlocking operation is to be performed by a device firmware of an Android-based device, and includes: a) determining whether a current touchpoint on a device touchscreen falls within a predetermined initial region, and proceeding to step b) if affirmative; b) decrementing a count value of a counter, determining whether the count value is a non- zero value, and proceeding to step c) if affirmative; c) determining whether a new current touchpoint falls within a predetermined unlock region, and proceeding to step d) if affirmative; and d) reporting coordinate information associated with the new current touchpoint to a device driver of the Android-based device, decrementing the count value, and repeating step d) until the count value is zero.

### BACKGROUND OF THE INVENTION

1. Field of the Invention

The present invention relates to a method of controlling unlocking operation of a device driver of an Android-based device.

2. Description of the Related Art

As Google Android becomes more popular, use of Android-based mobile devices is becoming more prevalent. To use an Android-based mobile device that is in a locked state, the mobile device must first be unlocked with a slide of an object (e.g., a finger) on the touchscreen. During the process of unlocking, the device firmware will record points (i.e., pixels) on the screen through which the object is slid. Among the points, the first point thus recorded when the object touches the touchscreen may be referred to as the object-down point, and the last point thus recorded when the object leaves the touchscreen may be referred to as the object-up point. The mobile device is successfully unlocked if the object-down point and the object-up point fall within first and second predetermined regions of the touchscreen, respectively, and remains locked if otherwise.

However, in practice, if sliding of the object in accordance with a predetermined unlock gesture is performed too fast, unlocking of the mobile device may fail due to failure of the firmware to report the object-up point to the device driver, which may lead to failure of the device driver to report a corresponding touch event to the operating system for unlocking the mobile device.

### SUMMARY OF THE INVENTION

Therefore, an object of the present invention is to provide a method of controlling unlocking operation of a device driver of an Android-based device, capable of alleviating the aforesaid drawback of the prior art.

According to the present invention, a method of controlling unlocking operation of a device driver of an Android-based device, which includes a touchscreen and a device firmware that is operatively associated with the touchscreen and the device driver, is to be performed by the device firmware and includes the steps of:

a) configuring the device firmware to, in response to detection of a current touchpoint on the touchscreen, determine whether the current touchpoint falls within a predetermined initial region on the touchscreen, and to proceed to step b) if affirmative;

b) configuring the device firmware to decrement a count value of a counter, to determine whether the count value is a non-zero value, and to proceed to step c) if affirmative;

c) configuring the device firmware to, in response to detection of a new current touchpoint on the touchscreen, determine whether the new current touchpoint on the touchscreen falls within a predetermined unlock region on the touchscreen, and to proceed to step d) if affirmative; and

d) configuring the device firmware to report coordinate information associated with the new current touchpoint to the device driver, to decrement the count value of the counter, and to repeat step d) until the count value is zero.

### BRIEF DESCRIPTION OF THE DRAWINGS

Other features and advantages of the present invention will become apparent in the following detailed description of the preferred embodiment with reference to the accompanying drawings, of which:

FIG. 1 is a flowchart illustrating steps of the preferred embodiment of a method of controlling unlocking operation of a device driver of an Android-based device, according to the present invention; and

FIG. 2 is a block diagram to illustrate an Android-based device with a touchscreen.

### DETAILED DESCRIPTION OF THE PREFERRED EMBODIMENT

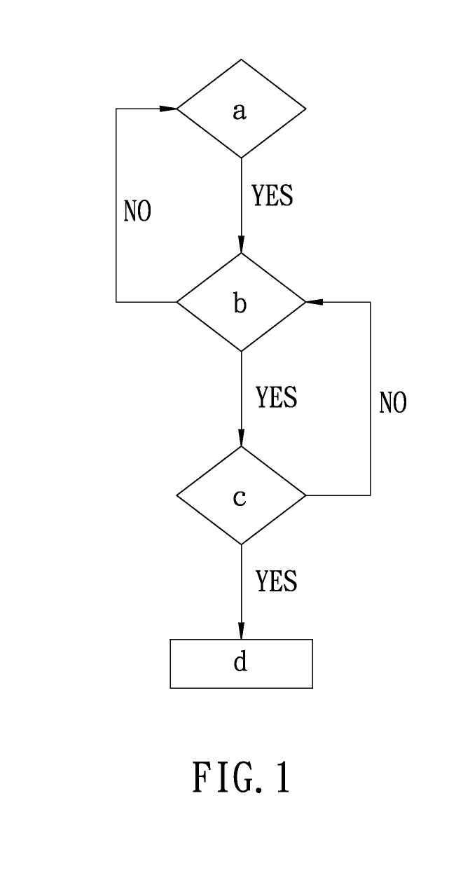

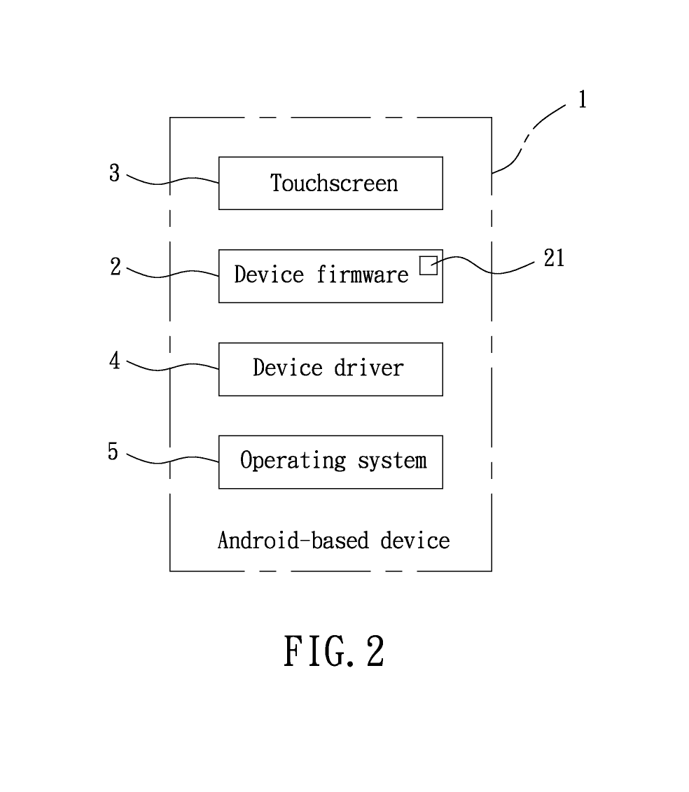

Referring to Figures 1 and 2, the preferred embodiment of a method of controlling unlocking operation of a device driver 4 of an Android-based device 1, which includes a touchscreen 3 and a device firmware 2 that is operatively associated with the touchscreen 1 and the device driver 4, is to be performed by the device firmware 2 and includes steps a) to d).

In step a) , the device firmware 2 is configured to, in response to detection of a current touchpoint on the touchscreen 3, determine whether the current touchpoint falls within a predetermined initial region on the touchscreen 3, and to proceed to step b) if affirmative.

In step b) , the device firmware 2 is configured to decrement a count value of a counter 21 thereof, to determine whether the count value is a non-zero value, to proceed to step c) if affirmative, and to reset the count value and to proceed back to step a) if otherwise.

In step c) , the device firmware 2 is configured to, in response to detection of a new current touchpoint on the touchscreen 3, determine whether the new current touchpoint falls within a predetermined unlock region on the touchscreen 3, to proceed to step d) if affirmative, and to proceed back to step b) if otherwise. This step may optionally include reporting the coordinate information associated with the new current touchpoint to the device driver 4 prior to proceeding back to step b).

In step d) , the device firmware 2 is configured to report coordinate information associated with the new current touchpoint to the device driver 4, to decrement the count value, and to repeat step d) until the count value is zero. In this embodiment, the count value is a positive integer.

Through repeating step d), the probability of the device firmware 2 successfully reporting the coordinate information associated with the new current touchpoint, that falls within the predetermined unlock region, to the device driver 4 is relatively increased. Upon receipt of the coordinate information from the device firmware 2, the device driver 4 is configured to generate a corresponding event for unlocking an operating system 5 of the Android-based device 1. That is, the probability of the device firmware 2 failing to report the coordinate information to the device driver 4 when required is lowered in the method of this invention. Thus, the Android-based device 1 is relatively responsive to fast unlock gesture performed on the touchscreen 3.

Furthermore, in this embodiment, the count value is decremented by one in step b) and in each repetition of step d). It is worth noting that the count value may be predetermined during a design phase. Alternatively, the count value may be adaptively adjusted during operation.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A method of controlling unlocking operation of a device driver of an Android-based device, which includes a touchscreen and a device firmware that is operatively associated with the touchscreen and the device driver, said method to be performed by the device firmware and comprising the steps of:
a) configuring the device firmware to, in response to detection of a current touchpoint on the touchscreen, determine whether the current touchpoint falls within a predetermined initial region on the touchscreen, and to proceed to step b) if affirmative;
b) configuring the device firmware to decrement a count value of a counter, to determine whether the count value is a non-zero value, and to proceed to step c) if affirmative;
c) configuring the device firmware to, in response to detection of a new current touchpoint on the touchscreen, determine whether the new current touchpoint on the touchscreen falls within a predetermined unlock region on the touchscreen, and to proceed to step d) if affirmative; and
d) configuring the device firmware to report coordinate information associated with the new current touchpoint to the device driver, to decrement the count value of the counter, and to repeat step d) until the count value is zero.

2. The method as claimed in claim 1, wherein, when it is determined in step c) that the new current touchpoint does not fall within the predetermined unlock region on the touchscreen, the device firmware is configured to proceed back to step b).

3. The method as claimed in claim 2, wherein step c) optionally includes reporting the coordinate information associated with the new current touchpoint to the device driver prior to proceeding back to step b).

4. The method as claimed in claim 1, wherein the count value is decremented by one in step b) and in each repetition of step d).

5. The method as claimed in claim 1, wherein step b) further includes configuring the device firmware to reset the count value and to proceed back to step a) upon determining that the count value is zero.
